(19) United States
(12) Patent Application Publication
(10) Pub. No.: US 2020/0271062 A1
(43) Pub. Date: Aug. 27, 2020

(54) ACOUSTICALLY DAMPENED DUAL PATH DUAL PURGE VALVE ASSEMBLY

(71) Applicant: Padmini VNA Mechatronics Pvt. Ltd., Gurgaon (IN)

(72) Inventors: Kabir Bhandari, Gurgaon (IN); Torsten Gerlich, Bensheim (DE); Amardip Kumar, Gurgaon (IN); Kumar Abhishek, Gurgaon (IN)

(21) Appl. No.: 16/063,965

(22) PCT Filed: Jan. 9, 2017
(86) PCT No.: PCT/IB2017/050086

§ 371 Date: Jun. 19, 2018

(30) Foreign Application Priority Data
Jan. 9, 2016 (IN) 201611000867

(51) Int. Cl. F02D 41/00; F16K 31/06

(52) U.S. Cl. CPC F02D 41/004; F05D 2220/40; F16K 31/0689; F16K 31/0655

(57) ABSTRACT

The present invention, sealing element that dampens the acoustics of the dual path dual purge valve assembly is provided, that is incorporated into the valve itself, further the element shall absorb the kinetic energy of the impact and prohibit the sound transmission, due to its unique shape, configuration, angle, and placement, thereby obviating additional requirements of any type of decoupling devices. Further, the invention modifies dual purge valve assembly, to adequately and securely, install the sealing element. The sealing element is installed on the big moving core, which reduces the noise from touchdown.

### FIELD OF THE INVENTION

The present invention provides an acoustically dampened dual path dual purge valve assembly for turbo boosted engine. More specifically, the invention dampens the acoustics of the dual path dual purge valve assembly by providing “wing” shaped sealing element that absorbs the kinetic energy of the impact and prohibits the sound transmission.

### BACKGROUND OF THE INVENTION

Motor vehicles are the primary mode of transportation around the world in terms of number of users. However, not everything is pleasant when 1.2 billion cars are on streets around the world. The major concern being pollution such as exhaust gases, noise pollution etc.

The noise pollution causes stress related illnesses, speech interference, hearing loss, sleep disruption, loss of productivity etc. Now such noise pollution is not only due to use of horn but there are several mechanical components that execute motion or movement to actually run a motor vehicle. Most industrialized countries have regulations about the noise limits. Therefore, automobiles industry is making changes in each of their mechanical component to make their car environmentally friendly and quieter.

One such component that is being customized to reduce noise is the purge valve; Dual purge systems typically use two check valves. During a first mode of operation, vacuum pressure places the first check valve in an open position and the second check valve in a closed position. In a second mode of operation, pressurized air places the first check valve in a closed position. The second check valve is placed in an open position by vacuum pressure coming either from the pressure sink in front of the compressor stage of the turbocharger or from an additional device like an ejector using a sonic nozzle which converts boosted air into vacuum pressure. These are more advanced purge valves that are developed such as dual path dual purge valve system and assembly with two purge valves connected to facilitate the use of the low flow valve to be operated as a pilot valve for the high flow valve. This smart routing provides pressure compensation for the high flow valve, when the valve is enabled. This decreases the force requirement of the high flow valve and gives an option to install a smaller cost efficient solenoid valve.

The major drawback of dual purge valve assembly or the conventional purge valve assembly is the noise created due to direct impact of the plunger on the housing. Traditional canister purge valves driven in duty cycle mode with a PWM signal suffer from the noise coming from the impact of the armature into the end positions of the valve. This structural borne noise is evidently audible by the driver and is a source of complaints. Due to this car manufacturers are putting a vast effort into avoiding this noise by decoupling the valve itself from all sound emitting structures in the vehicle. The conventional technique for minimizing the noise is by installing the decoupling devices that merely channels the noise, which is more of an attempt to remedy the symptoms rather than the cause.

Both solutions suffer from the reduced life time expectations which are in contradiction to the requirements. In addition these elements contribute an additional amount of cost.

U.S. Pat. No. 8,079,568B provides a valve is described having an inlet, an outlet, a sealing element and a device to generate a magnetic field, whereby the sealing element can be moved at least partially by the device and whereby the sealing element connects the inlet to the outlet in a fluid-conducting manner in that the sealing element lifts off at least partially from a valve seat wherein the sealing element is made at least partially of a foam element that can be deformed by the magnetic field. The invention describes a valve that minimizes the acoustics by the application of a foam element either as an additional dampening element at the plunger or as the sole sealing or dampening element. US20080290306A1 a present invention is advantageously applied to a purge valve for purging evaporated fuel stored in a canister to an intake pipe of an engine. The purge valve has a fluid passage connecting an inlet port and an outlet port, and a normally closed valve port that is selectively opened by operation of an electromagnetic actuator is disposed in the fluid passage. A barrier pillar is disposed in the fluid passage between the inlet port and the valve port to suppress transmission of pulsating waves generated in the purge valve to the canister. Flow resistance of the barrier pillar is higher in a reverse flow direction from the valve port to the inlet port than in a normal flow direction from the inlet port to the valve port. The transmission of the pulsating waves is well suppressed by the barrier pillar while allowing a smooth flow from the canister into the purge valve.

U.S. Pat. No. 5,720,469 a two-port electromagnetic valve is disclosed. The electromagnetic valve incorporates a first port, a second port and a passage for communicating the first and second ports and a cylindrical bobbin having an electrical coil. A fixed core is arranged inside the cylindrical bobbin and has an inner space defined therein. A movable core is arranged near the fixed core. A valve is connected with the movable core for opening and closing the passage between both the ports. An insert member is arranged into the inner space of the fixed core.

US20060243939A1 an electromagnetic valve generally has a housing, a valve element, an electromagnetic driving portion and a filter. The housing forms a fluid flow passage therein. The valve element is installed in the housing to control a flow of a fluid through the fluid flow passage. The electromagnetic driving portion is installed in the housing to generate a magnetic attraction force when it is energized to actuate the valve element. At least a part of the electromagnetic coil is within the fluid flow passage. The filter is installed in the fluid flow passage on an upstream side of the at least a part of the electromagnetic driving portion to filtrate the fluid flowing through the fluid flow passage.

Therefore, there is a technological gap that requires noise reduction method, in a cost effective manner. All these prior art have a sealing element that stops the impact of the moving core, however all these sealing elements are flat, therefore there is no cushion to the impact. However, these elements are connected to the housing to reduce noise.

Further all of the cited prior art have one moving core therefore the sealing element stops the impact is of the moving core to the housing. However, in case of two moving core wherein the big moving core impacts the housing and the small moving core impacts the big moving core ,hence, the shape, configuration, placement and contour of the sealing element is very important.

### OBJECT OF THE INVENTION

Accordingly taking into account the shortcomings of the prior art the primary object of the invention is to provide an acoustically dampened dual path dual purge valve assembly.

Yet another object of the invention is to provide a sealing element that absorbs the kinetic energy of the impact.

Yet another object of the invention is to provide a sealing element that absorbs the kinetic energy of the impact due to its shape, contour and configuration.

Yet another object of the invention is to provide a sealing element with shape, contour and configuration to provide a recoil movement.

Yet another object of the invention is to provide a sealing element with shape, contour and configuration to provide a recoil movement that absorbs the kinetic energy of the impact, prohibits the sound transmission and generation.

Yet another object of the invention is to provide a sealing element that can reduce structural borne noise due to dual moving core, small and big moving core.

Yet another object of the inventions is to minimize the structural borne noise due to the direct impact of the plunger on the housing of the dual path dual purge valve assembly.

Yet another object of the invention is to provide a dual path dual purge valve assembly with element that shields the acoustics of the dual purge valve by incorporating the sealing element into the valve itself.

Yet another object of the invention is to modify dual path dual purge valve assembly, to adequately and securely, install the sealing element.

Yet another object of the invention is to provide a sealing element installed on the big moving core.

Yet another object of the invention is to provide a sealing element which reduces the noise from the touchdown, as the plunger of the duty cycle valve does not have a direct impact on the housing of the valve, thus avoiding structural borne noise.

Yet another object of the invention is to provide decoupling from the shape of the sealing element of the big moving core due to its unique sealing seat conformation which reduces the noise from the touchdown, due to an additional elasticity property.

Yet another object of the invention is to obviate additional decoupling devices to channelize acoustics produced from dual path dual purge valve assembly or other conventional purge valve assembly.

Still another object of the invention is to acoustically dampen dual purge valve assembly by providing a sealing element attached on to the big moving core, with conformation of sealing seat which reduces the noise from the touchdown and absorbs the kinetic energy of the impact; thereby obviate additional decoupling devices to channelize acoustics.

### SUMMARY OF THE INVETION

The present invention provides acoustically dampened dual path dual purge valve assembly for a turbo boosted engine. More specifically, the invention dampens the acoustics of the dual purge valve assembly by providing a sealing element with shape, contour and configuration to provide a recoil movement that absorbs the kinetic energy of the impact, prohibits the sound transmission and generation.

In the most preferred embodiment of the current invention the sealing element is configured in the form of a “wing” shaped sealing element that absorbs the kinetic energy of the impact and prohibits the sound radiation. Although a shape has been defined but there may be other shapes with similar function of providing recoil action may be also installed such as anvil shape, or a ribbed shaped configuration on at least one lateral side.

In an embodiment of the present invention, sealing element that dampens the acoustics of the dual path dual purge valve assembly is provided, that is incorporated into the valve itself, further the element shall absorb the kinetic energy of the impact and prohibit the sound transmission, due to its unique shape, configuration, angle, and placement, thereby obviating additional requirements of any type of decoupling devices. Further, the invention modifies dual purge valve assembly, to adequately and securely, install the sealing element. The sealing element is installed on the big moving core, which reduces the noise from touchdown.

In yet another embodiment of the present invention, an elastic sealing element (thermoplastic or elastomeric element) that prevents plunger of the duty cycle valve to directly impact the housing of the valve, thus minimizing or avoiding structural borne noise.

In yet another embodiment of the present invention, the sealing element has the shape, configuration, placement and contour so that it can be applied to a dual path dual purge valve assembly, having dual moving core wherein the big moving core impacts the housing and the small moving core impacts the big moving core, hence the shape, configuration, placement and contour of the sealing element is very important. In a normal duty cycle where less purging is required only small moving core is moved the sealing element prevents impact of the small moving core on to the big moving core. In turbo boosted mode as maximum surface area for the purge flow is required both the big and small moving core are moved intermittently, therefore the sealing element prevents the noise due to impact of the big moving core to the housing. In an preferred illustration of the mechanism the small moving core impacts into the elastic sealing element of the big moving core, the elastic material itself shall transiently deform due to its material properties, and additionally the “wing” like shape having specific angle at the other side of the elastic element shall absorb the kinetic energy of the impact and prohibit the sound transmission. Further, the elastic element provides decoupling, due to its unique shape, configuration, angle and placement. Therefore, this particular arrangement and the unique design of the elastic element results in sealing and acoustic dampening in turbo boosted engine. Additionally, any material with significant heat resistant and elastic property can be used as the sealing element.

### BRIEF DESCRIPTION OF THE DRAWINGS

The present invention will become more fully understood from the detailed description and the accompanying drawings, wherein:

FIG. 1 illustrates the placement of the sealing element in the dual purge dual valve;

FIG. 2 illustrates the working of an acoustically sealed dual path dual purge valve assembly;

FIG. 3 illustrates the structural conformation of the sealing element according to the most preferred embodiment;

FIGS. 4a and 4b compare the sealing assembly provided in a conventional dual purge valve assembly and the acoustically sealed dual path dual purge valve assembly;

FIG. 5 illustrates the working of a conventional dual purge valve assembly without rubber sealant; and

FIG. 6 illustrates the conventional single purging valve elucidating the sealing element.

### DETAILED DESCRIPTION OF THE INVENTION

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

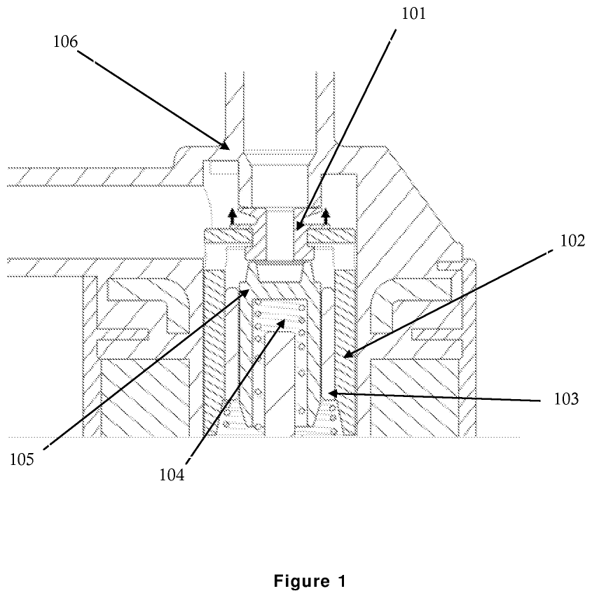

FIG. 1, illustrates the placement of the key embodiment of the present invention; sealing element 101, big moving core 102, bush 103, small spring 104, small moving core 105, housing 106, fix core 111 and core guider 112. The placement of the sealing element 101 minimizes the structural borne noise due to indirect impact of the plunger on the housing 106 of the dual path dual purge valve assembly. Although the figure elucidates the most preferred wing shaped configuration provides “wing” shaped sealing element that absorbs the kinetic energy of the impact and prohibits the sound radiation. Although a shape has been defined but there may be other shapes with similar function of providing recoil action may be also installed such as anvil shape, or a ribbed shaped configuration on at least one side. Further, a recoil action has been shown at one end only and marked with arrow head to show movement, however such wing shaped configuration may be provided at the other end of the sealing element 101.

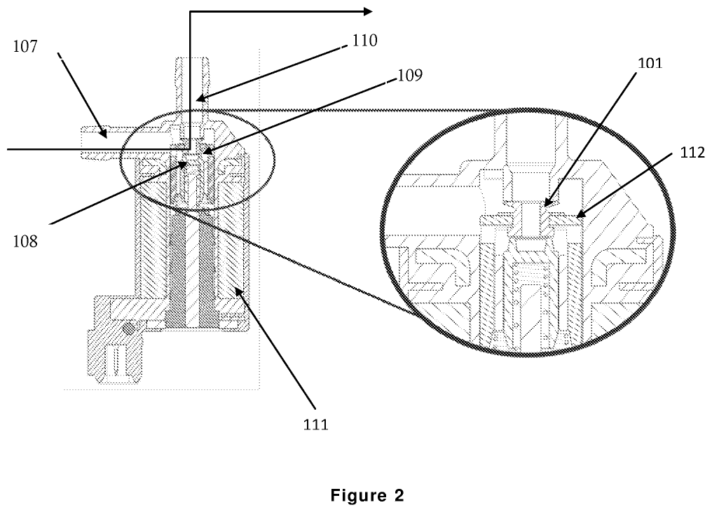

FIG. 2, illustrates the working of an acoustically sealed dual purge valve assembly; as shown the figure illustrates the working in case the valve is operated in duty cycle mode of operation, wherein the purging is done from the Canister Port 107, and regulated by the valves (Low Flow Valve 108, High Flow Valve 109) and Engine Port 110. The Low Flow Valve 108 mainly operates via the small spring 104 moving the small moving core 105 retracted during normal duty cycle, there by opening the valve intermittently. The High Flow Valve 109 operates by moving the big moving core 102, axially and intermittently. The working is illustrated in case the valve is operated in duty cycle mode, wherein the small moving core 105 of the valve moves between its two end positions against the small spring 104, i.e. the fixed core 111 and the big moving core 102. The big moving core 102 is kept in place by the outer spring (not shown) which comprises of lateral orifice for allowing the purge flow, when closed. During operation, the small moving core 105 is guided by a bush 103, which is assembled into the big moving core 102. The flow through the big moving core 102 is enabled through radial communicating orifices in the armature. The orifice in the centre of the big moving core 102 determines the real amount of the flow.

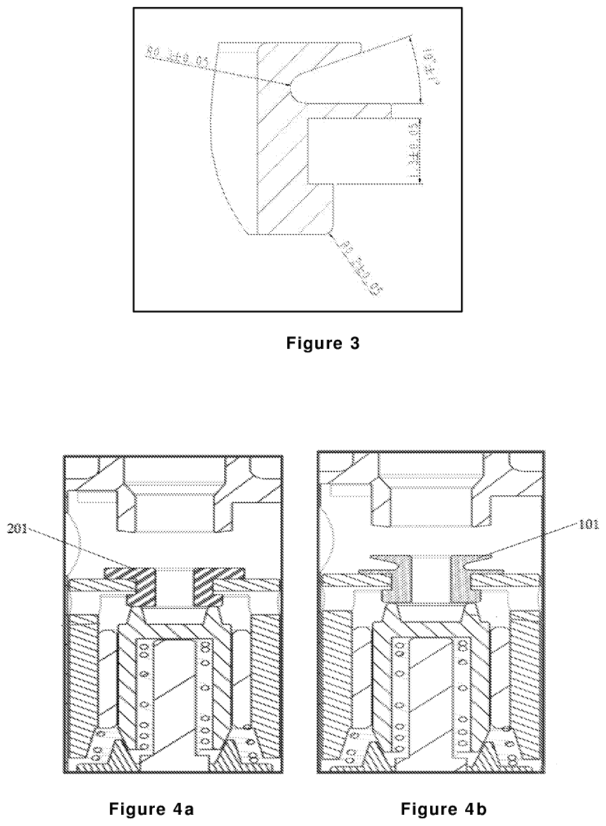

FIG. 3 illustrates the structural conformation of the sealing element. The figure provides one of the most preferred configurations, which may be varied. The sealing element is designed with shape, contour and configuration to provide a recoil movement. In the most preferred embodiment of the present invention, the sealing element is designed to mimic a “wing” like contour at the other side of the sealing element to absorb the kinetic energy of the impact and prohibit the sound transmission, thereby obviating additional costly coupling devices.

FIG. 4, compares the sealing assembly of a conventional dual purge valve assembly and the acoustically sealed dual purge valve assembly. The conventional dual purge valve assembly has a flat sealing element 201 and acoustically sealed dual purge valve assembly showing a wing shaped configuration of the sealing element 101, that absorb the kinetic energy of the impact. The wing shaped configuration of the sealing assembly 101, is seen in an anvil shaped configuration. Although, the shapes with similar function of providing recoil action may be also installed such as anvil shape, or a ribbed shaped configuration on at least one lateral side. Further, the sealing assembly 101 may have wing shaped configuration or shapes with similar function of providing recoil action may be also installed such as anvil shape, or a ribbed shaped configuration on at least one terminal end.

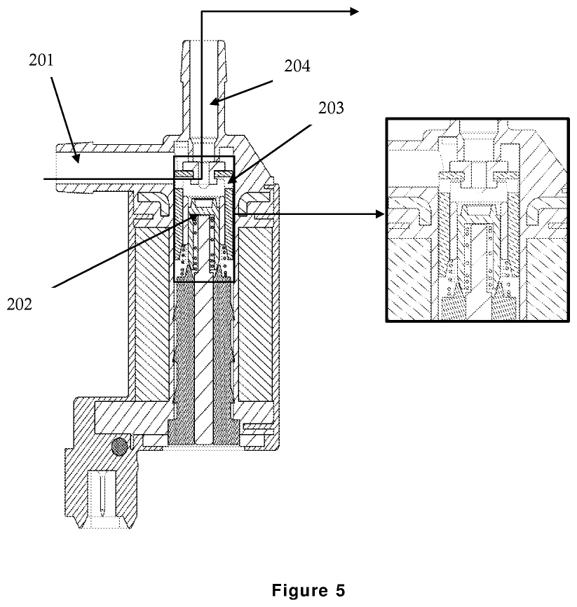

FIG. 5, illustrates the working of a conventional dual purge valve assembly without an acoustic decoupling sealant (205); wherein the purging is done from the Canister Port 201, and regulated by the valves (Low Flow Valve 202, High Flow Valve 203,) and Engine Port 204. The Figure is further zoomed in to magnify the conventional sealing element, showing the flat configuration of the sealing element.

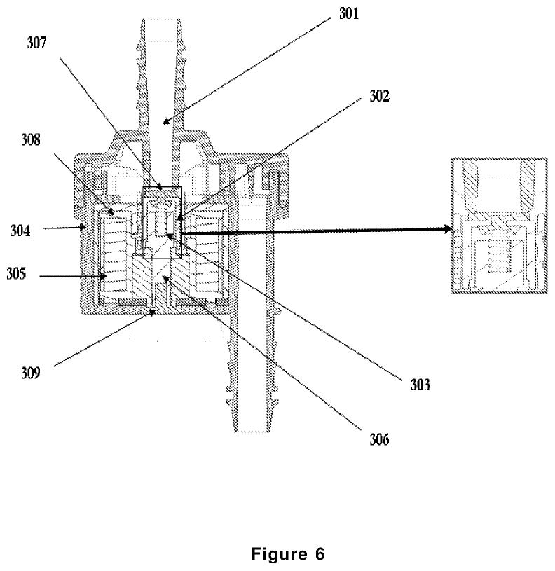

FIG. 6, illustrates the conventional purging valve and its sealing element, comprising of nozzle 301, moving core 302, spring 303, housing 304, coil 305, screw 306, sealing rubber 307, bobbin 308 and sealant 309. The present invention can also be accommodated into such devices to act as acoustic sealant and wing shaped configuration.

Accordingly, in most preferred embodiment of the present invention is proposed an acoustically dampened dual path dual purge valve assembly comprising of:
a. a housing (106) having an inlet and an outlet for purge flow;
b. a fix core (111) fixed into said housing (106), said fix core having an upper end and a lower end, said upper end having at least one protruding extension;
c. a big moving core (102) placed at least one big spring, wherein said big spring is placed around said extension of said fix core;
d. a small moving core (105) placed within the big moving core (102), said small moving core placed on at least one small spring (104), wherein said small spring is placed on said extension of said fix core;
e. a sealing element (101) placed on the top of said big moving core;
f. a core guider (112) attached laterally to the housing (102); and
g. a threaded pin inserted in the lower end of said fix core;
wherein:
said sealing element (101) is placed on top of said big moving core to limit its movement and is laterally supported via said core guider;
the sealing element dampens the acoustics of the dual path dual purge valve assembly absorbs the kinetic energy of the impact, prohibits the sound transmission and generation; and
said sealing element (101) has wing like contour and configuration on at least one terminal surface and having a ribbed side contour and configuration on at least one lateral side, allowing the sealing element to compress on the ribbed side to absorb impact and minimize noise.

We claim,:

1. An acoustically dampened dual path dual purge valve assembly comprising of:
a. a housing (106) having an inlet and an outlet for purge flow;
b. a fix core (111) fixed into said housing (106), said fix core having an upper end and a lower end, said upper end having at least one protruding extension;
c. a big moving core (102) placed at least one big spring, wherein said big spring is placed around said extension of said fix core;
d. a small moving core (105) placed within the big moving core (102), said small moving core placed on at least one small spring (104), wherein said small spring is placed on said extension of said fix core;
e. a sealing element (101) placed on the top of said big moving core;
f. a core guider (112) attached laterally to the housing (102); and
g. a threaded pin inserted in the lower end of said fix core;
wherein:
said sealing element (101) is placed on top of said big moving core to limit its movement and is laterally supported via said core guider;
the sealing element dampens the acoustics of the dual path dual purge valve assembly absorbs the kinetic energy of the impact, prohibits the sound transmission and generation; and
said sealing element (101) has wing like contour and configuration on at least one terminal surface and having a ribbed side contour and configuration on at least one lateral side, allowing the sealing element to compress on the ribbed side to absorb impact and minimize noise.

2. The dual valve assembly as claimed in claim 1, wherein the sealing element (101) of the present invention is an elastic sealing element or thermoplastic or elastomeric element.

3. The dual valve assembly as claimed in claim 1, wherein the sealing element (101) that prevents plunger of the duty cycle valve to directly impact the housing of the valve, thus minimizing or avoiding structural borne noise.

4. The dual valve assembly as claimed in claim 1, wherein the any material with significant heat resistant and elastic property can be used as the sealing element.

5. The dual valve assembly as claimed in claim 1, wherein in normal duty cycle where less purging is required only small moving core is moved the sealing element prevents impact of the small moving core on to the big moving core.

6. The dual valve assembly as claimed in claim 1, wherein in turbo boosted mode requiring maximum purge flow, both the big and small moving core moving intermittently, the sealing element prevents the noise due to impacts of the small moving core on to the big moving core, and that of the big moving core on to the housing.
